(19) United States
(12) Patent Application Publication
(10) Pub. No.: US 2020/0293754 A1
(43) Pub. Date: Sep. 17, 2020

(54) TASK EXECUTION METHOD, TERMINAL DEVICE, AND COMPUTER READABLE STORAGE MEDIUM

(71) Applicant: SHENZHEN ORBBEC CO., LTD., Shenzhen (CN)

(72) Inventors: Yuanhao HUANG, SHENZHEN (CN); Xu CHEN, SHENZHEN (CN)

(21) Appl. No.: 16/892,094

(22) Filed: Jun. 3, 2020

Related U.S. Application Data
(63) Continuation of application No. PCT/CN2018/113784, filed on Nov. 2, 2018.

(30) Foreign Application Priority Data
Dec. 4, 2017 (CN) 201711262543.0
Apr. 16, 2018 (CN) 201810336302.4

(51) Int. Cl. G06K 9/00; G06K 9/20; G06F 3/01; G06K 9/42; G06K 9/52

(52) U.S. Cl. CPC G06K 9/00255; G06K 9/00288; G06K 9/52; G06F 3/013; G06K 9/42; G06K 9/2018

(57) ABSTRACT

The present application provides a method, a terminal device, and a computer readable storage medium for executing a task. The method includes: in response to detecting a request for activating an application program, projecting invisible light into a space; obtaining an image comprising depth information; determining whether the image comprises an unauthorized face and determining whether a gaze direction of the unauthorized face is directed to the terminal device based on the image; and in response to determining that the gaze direction of the unauthorized face is directed to the terminal device, controlling the terminal device to perform an anti-peeping operation.

### CROSS-REFERENCE TO RELATED APPLICATION

The present application is a continuation application of International Patent Application No. PCT/CN2018/113784, filed with the China National Intellectual Property Administration (CNIPA) on Nov. 2, 2018, and entitled “TASK EXECUTION METHOD, TERMINAL DEVICE AND COMPUTER READABLE STORAGE MEDIUM”, which is based on and claims priority to and benefit of Chinese Patent Application No. 201711262543.0, filed with the CNIPA on Dec. 4, 2017, and Chinese Patent Application No. 201810336302.4, filed with the CNIPA on Apr. 16, 2018. The entire contents of all of the above-identified applications are incorporated herein by reference.

### TECHNICAL FIELD

The present application relates to the field of computer technologies, and more specifically, to a method, a terminal device, and a computer readable storage medium for executing a task.

### BACKGROUND

A human body has various unique features such as the face, the fingerprints, the irises, and the ears. The features are collectively referred to as biological features. Biometric authentication is widely used in a large quantity of fields such as security, home, and intelligent hardware. Currently, relatively mature biometric authentication (for example, fingerprint recognition and iris recognition) has been commonly applied to terminal devices such as mobile phones and computers.

For features such as the face, although related researches are already very thorough, recognition of the features, such as the face, is still not popular.

A current facial recognition manner is mainly a facial recognition manner based on a color image. Such a facial recognition manner may be affected by factors such as intensity of ambient light and an illumination direction, which may result in low recognition accuracy.

### SUMMARY

The present application provides a method for executing a task of a terminal device, a terminal device, and a computer readable storage medium, to improve accuracy of facial recognition.

According to a first aspect, a task execution method of a terminal device is provided. The method includes: projecting active invisible light into a space after an application program of the terminal device is activated; obtaining an image including depth information; analyzing the image to determine whether the image includes an unauthorized face and to determine whether a gaze direction of the unauthorized face is directed to the terminal device; and controlling the terminal device to perform an anti-peeping operation when the gaze is directed to the terminal device.

In an embodiment, the active invisible light is infrared flood light, and the image includes a pure infrared image.

In an embodiment, the image includes a depth image.

In an embodiment, the active invisible light includes infrared structured light, and the image comprises a depth image.

In an embodiment, the method further comprises: when the image includes both an authorized face and the unauthorized face, obtaining distance information including a distance between the unauthorized face and the terminal device and a distance between the authorized face and the terminal device; and when the distance between the unauthorized face and the terminal device is greater than the distance between the authorized face and the terminal device, determining the gaze direction of the unauthorized face.

In an embodiment, the distance information is obtained according to the depth information.

In an embodiment, the gaze direction is obtained according to the depth information.

In an embodiment, the anti-peeping operation includes turning off the terminal device, setting the terminal device into sleep, or issuing a peeping warning.

According to a second aspect, a computer readable storage medium is provided, for storing an instruction used to perform the method according to the first aspect or any possible implementation of the first aspect.

According to a third aspect, a computer program product is provided, which includes an instruction used to perform the method according to the first aspect or any possible implementation of the first aspect.

According to a fourth aspect, a terminal device is provided, including: an active light illuminator; a camera; a memory, storing an instruction; a processor, used to execute the instruction, to perform the method according to the first aspect or any possible implementation of the first aspect.

In an embodiment, the active light illuminator is an infrared structured light projection module, the camera comprises an infrared camera, the infrared camera and the infrared structured light projection module form a depth camera, and the image includes a depth image.

In a fifth aspect, a method for executing a task at a terminal device is provided. The method includes: in response to detecting a request for activating an application program, projecting invisible light into a space; obtaining an image comprising depth information; determining whether the image comprises an unauthorized face and determining whether a gaze direction of the unauthorized face is directed to the terminal device based on the image; and in response to determining that the gaze direction of the unauthorized face is directed to the terminal device, controlling the terminal device to perform an anti-peeping operation.

In a sixth aspect, a method for executing a task at a terminal device is provided. The method includes: in response to detecting a request for activating an application program, projecting invisible light into a space; obtaining an image comprising depth information; determining whether the image comprises a face based on the image; in response to determining that the image comprises a face, performing a face recognition to generate a recognition result; and controlling the terminal device to perform a task according to the recognition result.

In a seventh aspect, a terminal device is provided. The terminal device comprising: a light illuminator; a camera; a memory, storing an instruction; and a processor, used to execute the instruction to perform operations. The operations includes: in response to detecting a request for activating an application program, projecting invisible light into a space; obtaining an image comprising depth information; determining whether the image comprises an unauthorized face and determining whether a gaze direction of the unauthorized face is directed to the terminal device based on the image; and in response to determining that the gaze direction of the unauthorized face is directed to the terminal device, controlling the terminal device to perform an anti-peeping operation.

Compared with existing technologies, the present application uses invisible light illumination to resolve an ambient light interference problem, and performs facial recognition using an image including depth information, thereby improving accuracy of facial recognition. In addition, the present application performs the anti-peeping operation according to whether the image includes the unauthorized face, thereby improving security of the terminal device.

### BRIEF DESCRIPTION OF THE DRAWINGS

FIG. 1 is a schematic diagram of a facial recognition application, according to an embodiment of the present application.

FIG. 2 is a schematic structural diagram of a terminal device, according to an embodiment of the present application.

FIG. 3 is a flowchart of a method for executing a task, according to an embodiment of the present application.

FIG. 4 is a flowchart of a facial recognition method based on depth information, according to an embodiment of the present application.

FIG. 5 is a flowchart of a method for executing a task, according to another embodiment of the present application.

FIG. 6 is a schematic structural diagram of a terminal device, according to an embodiment of the present application.

### DETAILED DESCRIPTION OF THE INVENTION

To make the to-be-resolved technical problems, technical solutions, and beneficial effects of the embodiments of the present application more comprehensible, the following further describes the present application in detail with reference to the accompanying drawings and embodiments. It should be understood that the specific embodiments described herein are merely used for explaining the present application, but do not limit the present application.

It should be noted that, when an element is described as being “secured on” or “disposed on” another element, the element may be directly on the another element or indirectly on the another element. When an element is described as being “connected to” another element, the element may be directly connected to the another element or indirectly connected to the another element. In addition, the connection may be a function for securing the elements, or may be a function for circuit communication.

It should be understood that, a direction or location relationship indicated by a term, such as “length,” “width,” “above,” “under,” “front,” “rear,” “left,” “right,” “vertical,” “horizontal,” “top,” “bottom,” “inner,” or “outer,” is a direction or location relationship shown based on the accompanying drawings, and is merely for conveniently describing the embodiments of the present application and simplifying the description, but does not indicate or imply that a mentioned apparatus or element needs to have a particular direction and is constructed and operated in the particular direction. Therefore, the direction or location relationship is not a limitation to the present application.

In addition, terms “first” and “second” are only used to describe the objectives and do not indicate or imply relative importance or imply a quantity of the indicated technical features. In view of this, a feature defined to be “first” or “second” may explicitly or implicitly include one or more features. In the descriptions of the embodiments of the present application, “a plurality of” means two or more, unless otherwise definitely and specifically defined.

The facial recognition technology can be used in fields such as security and monitoring. Currently, with popularity of intelligent terminal devices (such as mobile phones and tablets), facial recognition may be applied to perform operations such as unlocking the terminal device and making a payment, or may be applied to a plurality of aspects such as entertainment and games. Most intelligent terminal devices, such as mobile phones, tablets, computers, and televisions, are equipped with a color camera. After an image including a face is captured by the color camera, facial detection and recognition may be performed using the image, thereby further executing another related application using a recognition result. However, an environment of a terminal device (particularly, a mobile terminal device such as a mobile phone or a tablet) usually changes, and imaging of the color camera may be affected by a change of the environment. For example, when light is weaker, a face cannot be imaged well. On the other hand, when the facial recognition is performed, randomness of a face posture and/or a distance between the face and a camera increases the difficulty and instability of the facial recognition.

The present application first provides a facial recognition method based on depth information and a terminal device. Invisible light or active invisible light is used to capture an image including the depth information, and the facial recognition is performed based on the image. Because the depth information is insensitive to lighting, accuracy of the facial recognition can be improved. Furthermore, based on the that, the present application provides a method for executing a task of a terminal device and a terminal device. A recognition result of the foregoing facial recognition method may be used as a basis to perform different operations such as unlocking the device and making a payment. The following describes the embodiments of the present application in detail with reference to the specific accompanying drawings.

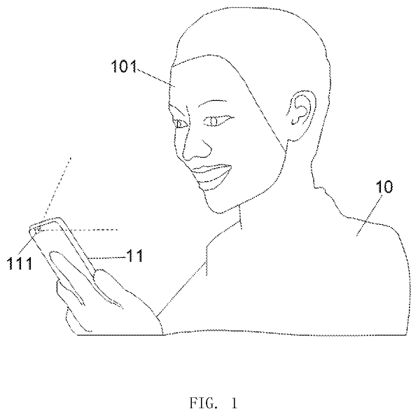

FIG. 1 is a schematic diagram of a facial recognition application, according to an embodiment of the present application. A user 10 holds a mobile terminal 11 (such as a mobile phone, a tablet, and a player), and the mobile terminal 11 includes a camera 111 that can obtain a target (face) image. When a current facial recognition application of unlocking the device is activated, the mobile terminal 11 is still in a locked state. The application may be activated by detecting a request from the user or device sensors. After an unlocking program is enabled, the camera 111 captures an image including a face 101, and performs the facial recognition on the face in the image. When the recognized face is an authorized face, the mobile terminal 11 is unlocked. Otherwise, the mobile terminal 11 remains in the locked state. If the current facial recognition application is making a payment or activating another application, a principle of the application is similar to that of the unlocking application.

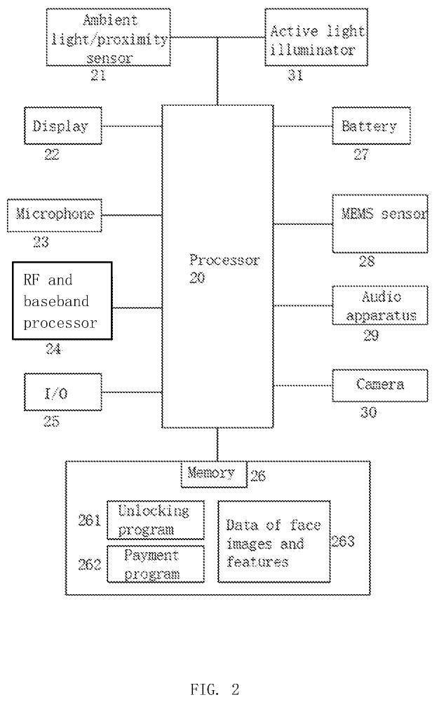

FIG. 2 is a schematic structural diagram of a terminal device, according to an embodiment of the present application. In some embodiments, the terminal device mentioned in the present application may be referred to as a facial recognition apparatus. The terminal device, for example, may be the mobile terminal 11 shown in FIG. 1. The terminal device may include a processor 20, an ambient light/proximity sensor 21, a display 22, a microphone 23, a radio-frequency (RF) and baseband processor 24, an interface 25, a memory 26, a battery 27, a micro electromechanical system (MEMS) sensor 28, an audio apparatus 29, a camera 30, and the like. These components are coupled to the processor 20. Individual units in FIG. 2 may be connected by using a circuit to implement data transmission and signal communication. FIG. 2 is merely an example of a structure of the terminal device. In other embodiments, the terminal device may include fewer or more structures.

The processor 20 may be used to control the entire terminal device. The processor 20 may be a single processor, or may include a plurality of processor units. For example, the processor 20 may include processor units having different functions.

The display 22 may be used to display an image to present an application or the like to a user. In addition, in some embodiments, the display 22 may also include a touch function. In this case, the display 22 may serve as an interaction interface between a human and a machine, which is used to receive input from a user.

The microphone 23 may be used to receive voice information, and may be used to implement voice interaction with a user.

The RF and baseband processor 24 may perform a communication function of the terminal device, for example, receiving and translating a signal, such as voice or text, to implement information communication between remote users.

The interface 25 may be used to connect the terminal device to the outside, to further implement functions such as the data transmission and power transmission. The interface 25, for example, may be a universal serial bus (USB) interface, a wireless fidelity (Wi-Fi) interface, or the like.

The memory 26 may be used to store an application program such as an unlocking program 261 or a payment program 262. The memory 26 may also be used to store related data required by execution of the application programs, for example, data 263 such as a face image and a feature. The memory 26 may also be used to store code or data included in an execution process of the processor 20.

The memory 26 may include a single memory or a plurality of memories, and may be in a form of any memory that may be used to save data, for example, a random access memory (RAM) or a flash memory. It may be understood that, the memory 26 may be a part of the terminal device, or may exist independently of the terminal device. For example, communication between data stored in a cloud memory and the terminal device may be performed through the interface 25 or the like. The application program, such as the unlocking program 261 and the payment program 262, is usually stored in a computer readable storage medium (such as a non-volatile readable storage medium). When the application is executed, the processor 20 may invoke a corresponding application in the storage medium for execution. Some data involved in the execution of the program, such as an authorized face image or authorized facial feature data, may also be stored in the memory 26. It should be understood that, the term of computer in the computer readable storage medium is a general concept, which may refer to as any device having an information processing function. In the embodiments of the present application, the computer may refer to the terminal device.

The terminal device may further include an ambient light/proximity sensor. The ambient light sensor and the proximity sensor may be integrated as a single sensor, or may be an independent ambient light sensor and an independent proximity sensor. The ambient light sensor may be used to obtain lighting information of a current environment in which the terminal device is located. In an embodiment, screen brightness may be automatically adjusted based on the lighting information, so as to provide more comfortable display brightness for eyes. The proximity sensor may measure whether an object approaches the terminal device. Based on this, some specific functions may be implemented. For example, during a process of answering a phone, when a face is close enough to the terminal device, a touch function of a screen can be turned off to prevent accidental touch. In some embodiments, the proximity sensor can quickly determine an approximate distance between the face and the terminal device.

The battery 27 may be used to provide power. The audio apparatus 29 may be used to implement voice input. The audio apparatus 29, for example, may be a microphone or the like.

The MEMS sensor 28 may be used to obtain current state information, such as a location, a direction, acceleration, or gravity, of the terminal device. The MEMS sensor 28 may include sensors such as an accelerometer, a gravimeter, or a gyroscope. In an embodiment, the MEMS sensor 28 may be used to activate some facial recognition applications. For example, when the user picks up the terminal device, the MEMS sensor 28 may obtain such a change, and simultaneously transmit the change to the processor 20. The processor 20 may invoke an unlocking application program in the memory 26, to activate the unlocking application.

The camera 30 may be used to capture an image. In some applications, for example, during execution of a selfie-taking application, the processor 20 may control the camera 30 to capture an image, and transmit the image to the display 22 for display. In some embodiments, for example, for an unlocking program based on facial recognition, when the unlocking program is activated, the camera 30 may capture the image. The processor 20 may process the image (including facial detection and recognition), and execute a corresponding unlocking task according to a recognition result. The camera 30 may be a single camera, or may include a plurality of cameras. In some embodiments, the camera 30 may include an RGB camera or a gray-scale camera for capturing visible light information, or may include an infrared camera and/or an ultraviolet camera for capturing invisible light information. In some embodiments, the camera 30 may include a depth camera for obtaining a depth image. The depth camera, for example, may be one or more of the following cameras: a structured light depth camera, a time of flight (TOF) depth camera, a binocular depth camera, and the like. In some embodiments, the camera 30 may include one or more of the following cameras: a light field camera, a wide-angle camera, a telephoto camera, and the like.

The camera 30 may be disposed at any location on the terminal device, for example, a top end or a bottom end of a front plane (that is, a plane on which the display 22 is located), a rear plane, or the like. In an embodiment, the camera 30 may be disposed on the front plane, for capturing a face image of the user. In an embodiment, the camera 30 may be disposed on the rear plane, for taking a picture of a scene. In an embodiment, the camera 30 may be disposed on each of the front plane and the rear plane. Cameras on both planes may independently capture images, and may simultaneously capture images controlled by the processor 20.

The light illuminator, such as an active light illuminator 31, may use a form, such as a laser diode, a semiconductor laser, a light emitting diode (LED), as a light source thereof, and is used to project light or active light. The active light projected by the active light illuminator 31 may be infrared light, ultraviolet light, or the like. In an embodiment, the active light illuminator 31 may be used to project infrared light having a wavelength of 940 nm. Therefore, the active light illuminator 31 can work in different environments, and is less interfered by ambient light. A quantity of the active light illuminators 31 is used according to an actual requirement. For example, one or more active light illuminators may be used. The active light illuminator 31 may be an independent module mounted on the terminal device, or may be integrated with another module. For example, the active light illuminator 31 may be a part of the proximity sensor.

For an application based on the facial recognition, for example, unlocking the device or making a payment, the existing facial recognition technology based on a color image has encountered many problems. For example, both intensity of the ambient light and a lighting direction will affect the collection of face images, feature extraction, and feature comparison. In addition, on a condition that there is no visible light illumination, the existing facial recognition technology based on the color image cannot obtain the face image. That is, facial recognition cannot be performed, resulting in a failure of an application execution. Accuracy and a speed of facial recognition affect experience of an application based on facial recognition. For example, for the unlocking application, higher recognition accuracy leads to higher security, and a higher speed leads to more comfortable user experience. In an embodiment, a misrecognition rate of one-hundred-thousandth and even one millionth and several tens of milliseconds and even higher recognition speeds are considered to provide better facial recognition experience. However, in the facial recognition technology based on a color image, factors such as lighting, an angle, and a distance heavily affect the recognition accuracy and speed during capturing of the face image. For example, when an angle and a distance of the currently captured face are different from those of an authorized face (generally, a target comparison face that is input and stored in advance), during feature extraction and comparison, more time is consumed, and the recognition accuracy may also be reduced.

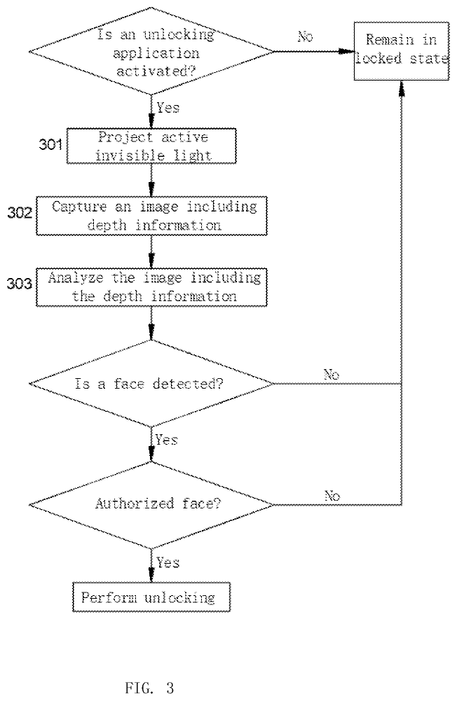

FIG. 3 is a schematic diagram of an unlocking application based on facial recognition, according to an embodiment of the present application. The unlocking application may be stored in a terminal device in a form of software or hardware. If the terminal device is in a locked state, the unlocking application is executed after being activated. In an embodiment, the unlocking application is activated according to output of a MEMS sensor. For example, after the MEMS sensor detects a certain acceleration, the unlocking application is activated, or when the MEMS sensor detects a specific orientation (an orientation of the device in FIG. 1) of the terminal device, the unlocking application is activated. After the unlocking application is activated, the terminal device uses an active light illuminator to project active invisible light (301) onto a target object such as a face. The projected active invisible light may be light having a wavelength of infrared light, ultraviolet light, or the like, or may be light in a form of flood light, structured light, or the like. The active invisible light illuminates the target, to avoid a problem that a target image cannot be obtained due to factors such as an ambient light not directing to the face and/or lack of the ambient light. Subsequently, a camera is used to capture the target image. To improve accuracy and a speed of the facial recognition of a traditional color image, in the present application, the captured image includes depth information of the target (302). In an embodiment, the camera is an RGBD camera, and the captured image includes an RGB image and a depth image of the target. In an embodiment, the camera is an infrared camera, and the captured image includes an infrared image and a depth image of the target. The infrared image herein includes a pure infrared flood light image. In an embodiment, the image captured by the camera is a structured light image and a depth image. It may be understood that, the depth image reflects the depth information of the target, such as a distance, a size, and a posture of the target, which can be obtained based on the depth information. Therefore, analysis may be performed based on the obtained image, to implement facial detection and recognition. After a face is detected, and it is determined that the current face is an authorized face after the face is recognized, the unlocking application is enabled, and the terminal device will be unlocked.

In an embodiment, when the terminal device is activated by mistake, a waiting time can be set at this time. During the waiting time, active invisible light is projected, and an image is captured and analyzed. If no face is detected when the waiting time ends, the unlocking application is turned off and waits for next activation.

The facial detection and recognition may be based on only the depth image, or may be based on a two-dimensional (2D) image and the depth image. The two-dimensional image herein may be the RGB image, the infrared image, the structured light image, or the like. For example, in an embodiment, an infrared LED floodlight and a structured light projector respectively project infrared flood light and structured light. The infrared image is used to successively obtain the infrared image and the structured light image. Furthermore, the depth image may be obtained based on the structured light image, and the infrared image and the depth image are separately used during facial detection. It may be understood that, invisible light herein includes the infrared flood light and infrared structured light. During projection, a time-division projection or simultaneous projection manner may be used.

In an embodiment, the analyzing of the depth information in the image includes obtaining a distance value of the face. The facial detection and recognition are performed with reference to the distance value, so as to improve accuracy and speeds of the facial detection and recognition. In an embodiment, the analyzing of the depth information in the image includes obtaining posture information of the face. The facial detection and recognition are performed with reference to the posture information, so as to improve accuracy and speeds of the facial detection and recognition.

By using the depth information, the facial detection may be accelerated. In an embodiment, for a depth value of each pixel in the depth image, a size of a pixel region occupied by the face may be preliminarily determined by using an attribute such as a focal length of the camera. Facial detection is then directly performed on the region of the size. Therefore, a location and a region of the face may be quickly found.

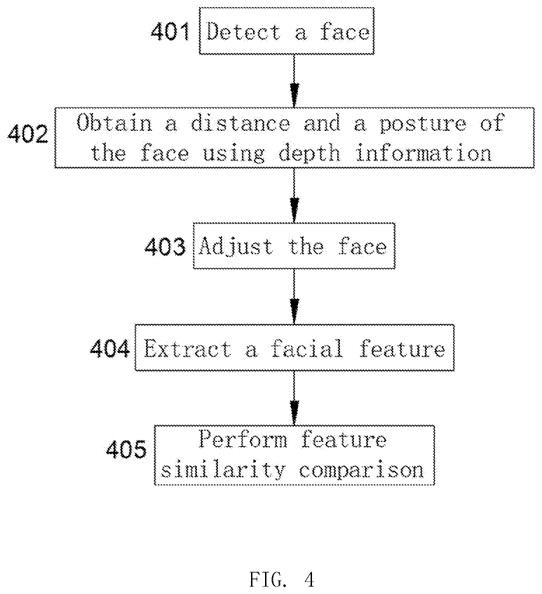

FIG. 4 is a schematic diagram of facial detection and recognition based on depth information, according to an embodiment of the present application. In this embodiment, an infrared image and a depth image of a face are used as an example for description. After a current face is detected (401), similarity comparison between an infrared image of the current face and an infrared image of an authorized face may be performed. Since a size and a posture in the infrared image of the current face are mostly different from those in the infrared image of the authorized face, accuracy of facial recognition may be affected when facial comparison is performed. Therefore, in this embodiment, a distance and a posture of a face may be obtained by using depth information (402). Then, the infrared image of the current face or the infrared image of the authorized face is adjusted by using the distance and the posture, to keep the sizes and the postures of the two images consistent (that is, approximately the same). For a size of a face region in the image, according to an imaging principle, a farther distance leads to a smaller face region. Therefore, if a distance of the authorized face is known, an authorized face image or a current face image may be adjusted, that is, be scaled up or shrunk down, according to a distance of the current face (403), so that sizes of regions of the two faces are similar. The posture may also be adjusted by using the depth information (403). One manner is that, a 3D model and the infrared image of the authorized face are input in a face input stage. When facial recognition is performed, a posture of the current face is recognized according to the depth image of the current face, and two-dimensional projection is performed on the 3D model of the authorized face based on the posture information, to project the infrared image of the authorized face having a posture the same as the posture of the current face. Then, feature extraction (404) and feature similarity comparison (405) are performed on the infrared image of the authorized face and the infrared image of the current face. Since postures of the two faces are similar, facial regions and features included in the images are also similar, accuracy of facial recognition is improved. Another manner is that, after posture information of a face is obtained, correction is performed on the infrared image of the current face. For example, the infrared image of the current face and the infrared image of the authorized face are uniformly corrected to infrared front face images, and then, feature extraction and comparison are performed on the infrared front face image of the current face and the infrared front face image of the authorized face.

In general, the distance and the posture information of the face can be obtained based on the depth information. Furthermore, the face image may be adjusted using the distance and/or the posture information. Therefore, the size and/or the posture of the current face image are/is the same as those/that of the authorized face image, thereby accelerating the facial recognition and improving accuracy of facial recognition.

It may be understood that, the unlocking application based on the facial recognition is also applicable to another application such as payment or authentication.

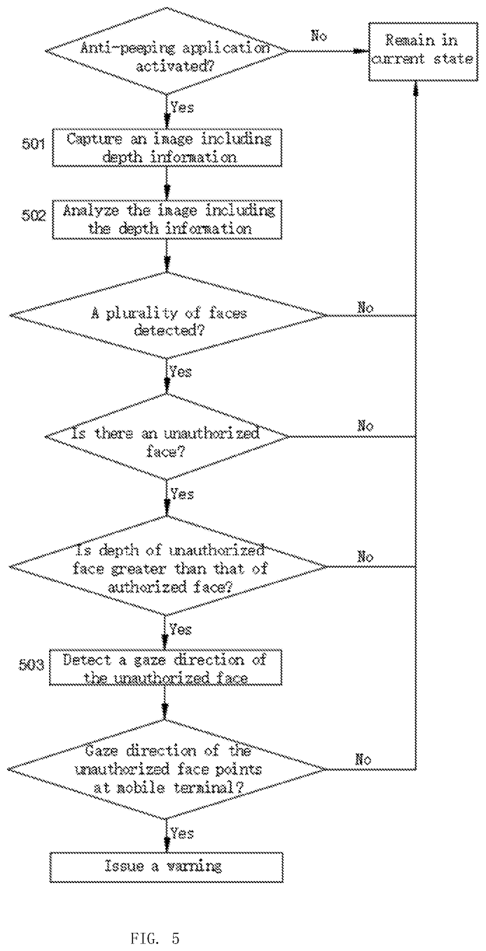

In an embodiment, facial recognition based on depth information may further be applied to an anti-peeping application. FIG. 5 is a schematic flowchart of an anti-peeping method, according to an embodiment of the present application. An anti-peeping application is stored in a memory in a form of software and hardware. After an application is activated (for example, when MEMS-based sensor data, or an application or a program with high privacy is enabled), a processor may invoke and execute the application.

Two conditions need to be satisfied to constitute peeping. First, a face of a person who is peeping at a screen of a device (peeper or unauthorized face) is behind an authorized face (that is, a face of a person that is allowed to look at the screen, for example, an owner of a device), that is, a distance between the peeper and the device is greater than the distance between the owner and the device. The other condition is that a gaze of the peeper is on the peeped device. Therefore, in the present application, distance detection and gaze detection are performed by using depth information to implement the anti-peeping application.

In an embodiment, after the anti-peeping application is activated, a camera captures an image including depth information (501). Then, analysis is performed on the image including the depth information is analyzed (502). The analysis herein mainly includes facial detection and recognition. When a plurality of faces are detected, and an unauthorized face is included, whether a distance between the unauthorized face and a terminal device is greater than a distance between an authorized face and the terminal device is determined. If it is determined that the distance between the unauthorized face and the terminal device is greater than the distance between the authorized face and the terminal device, a gaze direction of the unauthorized face is further detected. When the gaze direction is directed to the device, the anti-peeping measure is taken, for example, sending an alarm or turning off a device display.

In an embodiment, determining whether there are a plurality of faces may be skipped. When an unauthorized face is detected, and a gaze of the unauthorized face is on the device, the anti-peeping measure will be taken.

It may be understood that, the procedure shown in FIG. 5 is only an example, steps and an order of the steps are only used for description but not as limitation.

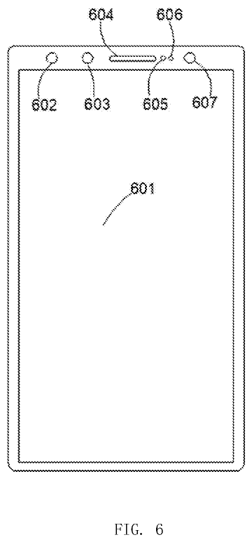

FIG. 6 is a schematic structural diagram of a terminal device, according to an embodiment of the present application. The terminal device may include a projection module 602 and a capturing module 607. The projection module 602 may be used to project an infrared structured light image (for example, project infrared structured light into a space in which a target is located). The capturing module 607 may be used to capture the structured light image. The terminal device may further include a processor (not shown in the figure). After receiving the structured light image, the processor may be used to calculate a depth image of the target using the structured light image. The structured light image includes structured light information, and may further include facial texture information. Therefore, the structured light image may also participate, as an infrared face image, together with the depth information in face to identity input and authentication. In this case, the capturing module 607 is a part of a depth camera, and is also an infrared camera. In other words, the depth camera and the infrared camera herein may be a same camera.

In some embodiments, the terminal device may further include an infrared floodlight 606 that may project infrared light having the same wavelength as that of structured light projected by the projection module 602. During capturing of a face image, the projection module 602 and the infrared floodlight 606 may be switched on or off in a time division manner, to respectively obtain a depth image and an infrared image of the target. The currently obtained infrared image is a pure infrared image. Compared with the structured light image, facial feature information included in the pure infrared image is more apparent, which can increase the accuracy of facial recognition.

The infrared floodlight 606 and the projection module 602 herein may correspond to the active light illuminator shown in FIG. 2.

In some embodiments, a depth camera based on a TOF technology may be used to capture depth information. In this case, the projection module 602 may be used to emit a light pulse, and the capturing module 607 may be used to receive the light pulse. The processor may be used to record a time difference between pulse emission and reception, and calculate the depth image of the target according to the time difference. In this embodiment, the capturing module 607 may simultaneously obtain the depth image and the infrared image of the target, and there is no visual difference between the two images.

In some embodiments, an extra infrared camera 603 may be used, to obtain an infrared image. When a wavelength of a light beam projected by the infrared floodlight 606 is different from a wavelength of a light beam projected by the projection module 602, the depth image and the infrared image of the target may be obtained by synchronously using the capturing module 607 and the infrared camera 603. A difference between such a terminal device and the terminal device described above is that, because cameras that obtain the depth image and the infrared image are different, there may be a visual difference between the two images. If an image without the visual difference is needed in calculation processing performed in subsequent facial recognition, registration needs to be performed between the depth image and the infrared image in advance.

The terminal device may further include devices, such as a receiver 604 and an ambient light/proximity sensor 605, to implement more functions. For example, in some embodiments, considering that infrared light is harmful to a human body, when a face is extremely close to the device, proximity of the face may be detected using the proximity sensor 605. When it indicates that the face is extremely close, projection of the projection module 602 may be turned off, or projection power may be reduced. In some embodiments, facial recognition and the receiver may be combined to make an automatic call. For example, when an incoming call is received by the terminal device, a facial recognition application may be enabled to enable the depth camera and the infrared camera to capture a depth image and an infrared image. When authentication succeeds, the call is answered, and then the device, such as the receiver, is enabled, to implement the call.

The terminal device may further include a screen 601, that is, a display. The screen 601 may be used to display image content, or may be used to perform touch interaction. For example, in an embodiment, an unlocking application of facial recognition may be applied when the terminal device is in a sleeping state. When a user picks up the terminal device, an inertia measurement unit in the terminal device may light the screen when recognizing acceleration due to picking up the device, and an unlocking application program is simultaneously enabled. A to-be-unlocked instruction may be displayed on the screen. In this case, the terminal device enables the depth camera and the infrared camera to capture the depth image and/or the infrared image. Further, facial detection and recognition are performed. In some embodiments, in a facial detection process, a preset gaze direction of eyes may be set as a direction in which a gaze of eyes is on the screen 601. Only when the gaze of the eyes is on the screen, the operation of unlocking the device may be further performed.

The terminal device may further include a memory (not shown in the figure). The memory is configured to store feature information input in an input stage, and may further store an application program, an instruction, and the like. For example, the above-described applications related to facial recognition (such as unlocking a device, making a payment, anti-peeping) are stored into the memory in a form of a software program. When an application program is needed, the processor invokes the instruction in the memory and performs an input and authentication method. It may be understood that, the application program may be directly written into the processor in a form of instruction code, to form a processor functional module or a corresponding independent processor with a specific function. Therefore, execution efficiency is improved. In addition, with development of technologies, a boundary between software and hardware gradually disappears. Therefore, the method in the present application may be configured in an apparatus in a software form or a hardware form.

The above are detailed descriptions of the present application with reference to specific preferred embodiments, and it should not be considered that the specific implementation of the present application is limited to the descriptions. A person skilled in the art may further make various equivalent replacements or obvious variations without departing from the concept of the present application and with the functions and use unchanged. Such replacements or variations should all be considered as falling within the protection scope of the present application.

What is claimed is:

1. A method for executing a task at a terminal device, the method comprising:
in response to detecting a request for activating an application program, projecting invisible light into a space;
obtaining an image comprising depth information;
determining whether the image comprises an unauthorized face and determining whether a gaze direction of the unauthorized face is directed to the terminal device based on the image; and
in response to determining that the gaze direction of the unauthorized face is directed to the terminal device, controlling the terminal device to perform an anti-peeping operation.

2. The method according to claim 1, wherein
the invisible light comprises infrared flood light, and the image comprises a pure infrared image, or
the invisible light comprises infrared structured light, and the image comprises a depth image.

3. The method according to claim 1, wherein determining whether the gaze direction of the unauthorized face is directed to the terminal device comprises:
when the image comprises an authorized face and the unauthorized face, obtaining distance information including a distance between the unauthorized face and the terminal device and a distance between the authorized face and the terminal device; and
when the distance between the unauthorized face and the terminal device is greater than the distance between the authorized face and the terminal device, determining the gaze direction of the unauthorized face.

4. The method according to claim 3, wherein the distance information is obtained according to the depth information.

5. The method according to claim 1, wherein the gaze direction is obtained according to the depth information.

6. The method according to claim 1, wherein the anti-peeping operation comprises turning off the terminal device, setting the terminal device into sleep, or issuing a peeping warning.

7. A method for executing a task at a terminal device, the method comprising:
in response to detecting a request for activating an application program, projecting invisible light into a space;
obtaining an image comprising depth information;
determining whether the image comprises a face based on the image;
in response to determining that the image comprises the face, performing a face recognition to generate a recognition result; and
controlling the terminal device to perform a task according to the recognition result.

8. The method according to claim 7, wherein
the invisible light comprises infrared flood light, and the image comprises a pure infrared image, or
the invisible light comprises infrared structured light, and the image comprises a depth image.

9. The method according to claim 7, further comprising:
extracting distance information and/or posture information of the face according to the depth information.

10. The method according to claim 9, wherein the performing the face recognition to generate the recognition result is based on:
adjusting the face or an authorized face using the distance information of the face so that the face and the authorized face have a same size.

11. The method according to claim 9, wherein the performing the face recognition to generate the recognition result is based on:
adjusting the face or an authorized face using the posture information of the face so that the face and the authorized face have a same posture.

12. The method according to claim 7, wherein the task comprises unlocking the terminal device or performing a payment.

13. A terminal device, comprising:
a light illuminator;
a camera;
a memory, storing instructions; and
a processor, used to execute the instructions to perform operations including:
in response to detecting a request for activating an application program, projecting invisible light into a space;
obtaining an image comprising depth information;
determining whether the image comprises an unauthorized face and determining whether a gaze direction of the unauthorized face is directed to the terminal device based on the image; and
in response to determining that the gaze direction of the unauthorized face is directed to the terminal device, controlling the terminal device to perform an anti-peeping operation.

14. The terminal device according to claim 13, wherein the light illuminator comprises an infrared structured light projection module, the camera comprises an infrared camera, the infrared camera and the infrared structured light projection module form a depth camera, and the image comprises a depth image.

15. The terminal device according to claim 13, wherein determining whether a gaze direction of the unauthorized face is directed to the terminal device comprises:
when the image comprises an authorized face and the unauthorized face, obtaining distance information including a distance between the unauthorized face and the terminal device and a distance between the authorized face and the terminal device; and
when the distance between the unauthorized face and the terminal device is greater than the distance between the authorized face and the terminal device, determining the gaze direction of the unauthorized face.

16. The terminal device according to claim 15, wherein the distance information is obtained according to the depth information.

17. The terminal device according to claim 13, wherein the gaze direction is obtained according to the depth information.

18. The terminal device according to claim 13, wherein the anti-peeping operation comprises turning off the terminal device, setting the terminal device into sleep, or issuing a peeping warning.
